(19) United States
(12) Patent Application Publication
(10) Pub. No.: US 2008/0147896 A1
(43) Pub. Date: Jun. 19, 2008

(54) Method, electronic device, computer program product and circuit assembly for memory allocation

(75) Inventor: Tero Soukko, Kirkkonummi (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/545,839

(22) Filed: Oct. 10, 2006

(51) Int. Cl. G06F 3/00

(52) U.S. Cl. 710/8

(57) ABSTRACT

A method, electronic device, computer program product and circuit assembly are provided for allocating memory to one or more peripheral devices based on parameters specific to the peripheral device and/or the electronic device to which the peripheral device is being connected. These parameters may be provided to the electronic device upon connection of the peripheral device, or known by the electronic device from the time of manufacture. The parameters may include, for example, the total amount of memory available on the electronic device, the amount of memory already reserved or allocated, the maximum number of peripheral devices that may be connected to the electronic device, the number of peripheral devices currently connected, the estimated size and frequency of a common data transfer associated with the peripheral device, and a likelihood and degree to which an actual data transfer will vary from the estimated size of a common data transfer.

### FIELD

In general, exemplary embodiments of the present invention relate to electronic device memory and, in particular, to the allocation of memory to one or more peripheral devices.

### BACKGROUND

As electronic devices, such as cellular telephones, personal digital assistance (PDAs), pagers, and the like, continue to become more advanced, these devices are often extended to support many different types of peripheral devices using connections, such as Bluetooth, Infrared, Universal Serial Bus (USB), or the like. Examples of peripheral devices that may be supported by and used to extend the capabilities of an electronic device may include, keyboards, speakers, mouse devices, gamepads and joysticks, scanners, digital cameras, printers, external storage, networking components, display devices, and the like.

In general, in order to support each peripheral device, the electronic device (e.g., cell phone) contains software for handling the transport of communication to and from the peripheral device, which is referred to herein as a “transport driver,” as well as software for controlling the peripheral device itself, which is referred to herein as a “peripheral driver.” Peripheral drivers are configured to communicate with the transport drivers, which in turn communicate with any transport hardware operating on the electronic device, such as a USB host (or On the Go (OTG)) controller (e.g., the Philips ISP 1362) and a USB transceiver (e.g., the Philips 1501).

Recently, electronic devices have been manufactured to support multiple simultaneous peripheral devices, wherein a user is able to install the respective peripheral drivers to the electronic device him- or herself. However, many of these electronic devices have a limited amount of memory. In many cases memory used for transferring payload data associated with a peripheral device must be allocated for the corresponding transport driver at the time the peripheral device is connected to the electronic device. One issue with pre-allocation at the time of connection is that it is often not known how much memory the peripheral device will require. Allocating too much memory results in valuable memory being wasted, while allocating too little memory may affect the performance of the peripheral connection.

Currently, the electronic device itself has no way of knowing the optimum amount of memory needed by each potential peripheral device. Peripheral devices and, in particular, the peripheral drivers associated with the peripheral devices, themselves may be able to tell how much memory they recommend that the transport driver reserve, but they may not know or respect the memory limitations of the device, particularly where more than one peripheral device is connected to the electronic device.

Many systems simply allocate the same amount of memory to each peripheral device regardless of how much memory that particular peripheral device may need. Alternatively, a few more advanced systems may assume that the peripheral device falls into one of several categories in terms of the amount of bandwidth the peripheral device is projected to use, and then allocate the memory accordingly. Neither of these allocation methods takes into consideration the numerous electronic and/or peripheral device-specific variables that may exist that affect the maximum amount of memory an electronic device can provide to each peripheral device, as well as the minimum amount of memory the peripheral device needs in order to function in an optimal manner.

A need, therefore, exists for a way in which electronic devices can intelligently allocate memory to multiple peripheral devices supported by the electronic device, taking into account, for example, any possible additional peripheral devices not yet connected to the electronic device, as well as any previously allocated memory.

### BRIEF SUMMARY

In general, exemplary embodiments of the present invention provide an improvement over the known prior art by, among other things, providing a technique for allocating memory to one or more peripheral devices, wherein multiple electronic and/or peripheral device-specific variables are considered when determining the optimum amount of memory to allocate to each peripheral device. In particular, according to exemplary embodiments, when a user connects a particular peripheral device to his or her electronic device, the peripheral driver associated with the peripheral device may communicate information associated with the peripheral device and, in particular, the amount of memory that will likely be needed to communicate with the peripheral device, to the electronic device operating system. In one exemplary embodiment, the peripheral driver communicates the information via an application programming interface (API) operating on the electronic device. Information communicated may include, for example, an estimated size of the most common data transfers associated with the peripheral device, how frequent those transfers will likely be, and how much each data transfer is likely to vary from the estimated size. Using the information received from the peripheral driver, the electronic device and, in particular, the electronic device's operating system, can calculate an appropriate and, in some instances, the optimal amount of memory to allocate to the peripheral device. In calculating the optimal amount of memory to allocate, the operating system of one exemplary embodiment take into account, among other things, the total number of peripheral devices that may be and currently are supported by the electronic device, and the total amount of available and previously allocated memory of the device.

In accordance with one aspect, a method is provided of allocating memory to one or more peripheral devices. In one exemplary embodiment, the method includes: (1) receiving one or more parameters associated with a peripheral device; and (2) calculating an amount of memory to allocate to the peripheral device based at least in part on the one or more parameters received.

In one exemplary embodiment, the parameters received are configured to provide an indication of a size and a frequency associated with a common data transfer associated with the peripheral device. In particular, according to one embodiment, the parameters may include some combination of an estimated size of a common data transfer, a frequency associated with the common data transfer, and a variation estimate associated with the estimated size of the common data transfer.

According to another exemplary embodiment, the parameters are received upon installation of a peripheral driver associated with the peripheral device to an electronic device. In this exemplary embodiment, calculating the amount of memory to allocate may include calculating the amount of memory to allocate based at least in part on one or more parameters associated with the electronic device. In particular, according to one exemplary embodiment, the method further includes determining both a total amount of memory available for one or more peripheral devices and an amount of memory previously allocated to one or more peripheral devices, and calculating an amount of memory remaining based on the total amount of memory available and the amount of memory previously allocated. In this exemplary embodiment, calculating the amount of memory to allocate based at least in part on one or more parameters associated with the electronic device may include calculating the amount to allocate based at least in part on the amount of memory remaining.

Similarly, according to another exemplary embodiment, the method may further include determining both a maximum number of peripheral devices capable of being simultaneously connected to the electronic device and a number of peripheral devices currently connected to the electronic device, and calculating a number of potential peripheral devices based on the maximum number of peripheral devices and the number of currently connected peripheral devices. In this exemplary embodiment, calculating the amount of memory to allocate based at least in part on one or more parameters associated with the electronic device comprises calculating the amount to allocate based at least in part on the number of potential peripheral devices.

According to another aspect, an electronic device is provided that is configured to allocate memory to one or more peripheral devices connected to the electronic device. In one exemplary embodiment the mobile device includes a processor and a memory in communication with the processor that stores an application executable by the processor, wherein the application is configured, upon execution, to: (1) receive one or more parameters associated with a peripheral device; and (2) calculate an amount of memory to allocate to the peripheral device based at least in part on the one or more parameters received

In accordance with yet another aspect, a computer program product is provided for allocating memory to one or more peripheral devices. The computer program product contains at least one computer-readable storage medium having computer-readable program code portions stored therein. The computer-readable program code portions of one exemplary embodiment include a first executable portion for receiving one or more parameters associated with a peripheral device, and a second executable portion for calculating an amount of memory to allocate to the peripheral device based at least in part on the one or more parameters received.

According to another aspect, a circuit assembly is provided for allocating memory to one or more peripheral devices. In one exemplary embodiment, the circuit assembly includes a first logic element for receiving one or more parameters associated with a peripheral device, and a second logic element for calculating an amount of memory to allocate to the peripheral device based at least in part on the one or more parameters received.

According to another aspect, an apparatus is provided for allocating memory to one or more peripheral devices. In one exemplary embodiment, the apparatus includes a means for receiving one or more parameters associated with a peripheral device, and a means for calculating an amount of memory to allocate to the peripheral device based at least in part on the one or more parameters received.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a flow chart illustrating the steps which may be taken in order to optimally allocate memory to one or more peripheral devices in accordance with an exemplary embodiment of the present invention; and

FIG. 2 is a schematic block diagram of a mobile station capable of operating in accordance with an exemplary embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### OVERVIEW

In general, exemplary embodiments of the present invention provide a method, electronic device, computer program product and circuit assembly for allocating memory to one or more peripheral devices. In particular, one or more parameters specific to a particular peripheral device, as well as one or more parameters that are specific to the electronic device to which the peripheral device is being connected, are used to calculate the optimal amount of memory to be reserved for or allocated to the peripheral device at the time of connection. One or more of the parameters may, for example, be provided to the electronic device by a peripheral driver associated with the peripheral device upon installation of the peripheral driver and/or connection of the peripheral device. In addition, one or more of the parameters may have been known by the electronic device from the time of manufacture. These parameters may include, for example, the total amount of memory available on the electronic device for allocation, the amount of memory already reserved or allocated to other peripheral devices, the maximum number of peripheral devices that may be simultaneously connected to the electronic device, the number of peripheral devices currently connected, the estimated size and frequency of a common data transfer associated with the peripheral device, and a likelihood and degree to which an actual data transfer will vary from the estimated size of a common data transfer.

Based on the foregoing, exemplary embodiments of the present invention provide an improved technique for allocating memory to a plurality of simultaneously connected peripheral devices, wherein a number of variables are considered in order to ensure that an appropriate amount of memory is allocated given the peripheral device's needs and the electronic device's limitations.

### METHOD OF ALLOCATING MEMORY TO PERIPHERAL DEVICES

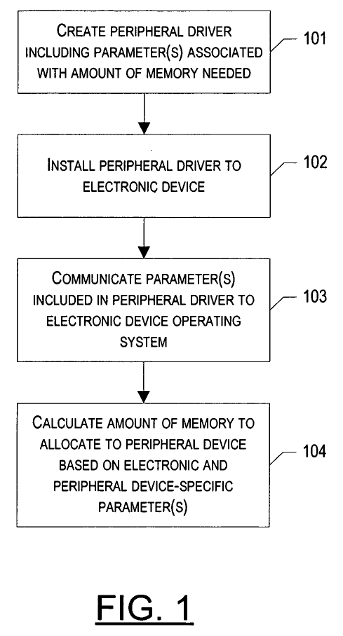

Reference is now made to FIG. 1, which provides a flowchart illustrating the steps which may be taken according to exemplary embodiments of the present invention in order to optimally allocate memory to one or more peripheral devices. As shown, the process begins at Step 101, where a peripheral device manufacturer or developer creates or develops the peripheral driver associated with a particular peripheral device (i.e., the software associated with the peripheral device that is used by the electronic device to which the software is installed (e.g., cell phone) to control the peripheral device). According to one exemplary embodiment, when developing the peripheral driver, the manufacturer or developer includes in or otherwise associates with the peripheral driver one or more parameters associated with, or providing an indication of, the amount of memory, or the size of the buffer, needed for communication with the peripheral device. These parameters may include, for example, EstimatedTransferSize, Frequency, and/or SizeVariation.

According to one exemplary embodiment, EstimatedTransferSize refers to the estimated size, for example in bytes, of the most common transfers associated with the peripheral device. For example, while a mouse driver may typically transfer only small amounts of data (e.g., 32-150 bytes), a printing driver typically transfers large amounts of data (e.g., 500,000 bytes). Frequency, on the other hand, may refer to how frequently transfers of the size estimated in the EstimatedTransferSize parameter are likely to occur. In one exemplary embodiment, this parameter may be selected from a group including, for example, “OCCASIONAL,” “CONSTANT,” or “BURST.” The term OCCASIONAL may be used to indicate that transfers will seldom or only occasionally be made, such as transfers associated with a mouse driver. In contrast, the term CONSTANT may be used to indicate that the data will continuously or constantly be transferred back and forth from the peripheral device (e.g., transfers associated with a video driver), and BURST may indicate that data will be transferred randomly or sporadically in large groups or bursts (e.g., transfers associated with a printing driver that involve large amount of data, but which only occur when something is being printed).

According to one exemplary embodiment, the parameter SizeVariation may be used to indicate a variation estimate, or how frequently and to what degree the actual size of the data transferred is likely to differ from the estimated or requested size (i.e., the EstimatedTransferSize). In one exemplary embodiment, SizeVariation may include an integer value falling between 0 and 100, wherein 0 may indicate that the actual size is never bigger than the estimated or requested size, and is usually smaller; any number between 1 and 49 may indicate that the actual size is usually smaller than the estimated size, but may also sometimes be bigger; 50 may indicate that the actual size is always as estimated or requested; any number between 51 and 99 may indicate that the actual size is usually or mainly bigger than the estimated size, but may sometimes be smaller; and 100 may indicate that the actual size is always as estimated or requested or bigger. In this embodiment, larger numbers therefore represent a greater likelihood that the actual size is larger than the estimated size and smaller numbers represent a greater likelihood that the actual size is smaller than the estimated size.

As one of ordinary skill in the art will recognize, other similar parameters may be included in the peripheral driver in order to provide information regarding the amount of memory needed by the corresponding peripheral device. The aforementioned parameters are provided for exemplary purposes only and should not be taken in any way as limiting the scope of exemplary embodiments of the present invention.

Returning to FIG. 1, in the next step of the process of one exemplary embodiment, the user of an electronic device, such as a cell phone, PDA, pager, or the like, installs the peripheral driver developed in Step 1 and associated with a particular peripheral device (e.g., keyboard, display, joystick, mouse, external memory, etc.) to his or her electronic device. (Step 102). Following installation, according to one exemplary embodiment, when the peripheral device is plugged into, or otherwise connected to, the electronic device, the peripheral driver, in Step 103, uses an application programming interface (API) operating on the electronic device to tell the electronic device the kind of resources it needs for communications associated with the use of the peripheral device. In particular, the peripheral driver provides the electronic device with various parameters including, for example, those discussed above, which describe the amount and frequency of data transfers associated with the peripheral device. As one of ordinary skill in the art will recognize, resources needed may differ greatly depending upon the type of peripheral device being connected to and supported by the electronic device. For example, a device used for video or wireless streaming may require a lot of bandwidth, while a device, such as a mouse or keyboard, may require very little. By providing the electronic device with these peripheral device-specific parameters, exemplary embodiments of the present invention enable the electronic device to make a more educated and, presumably, more accurate, assessment of the peripheral device's memory needs.

Next, in Step 104, the electronic device operating system (or other application) of one exemplary embodiment may calculate the amount of memory to allocate to the peripheral device based on multiple electronic and/or peripheral device-specific parameters or variables that affect the maximum and minimum amount of memory that can and should be allocated to the peripheral device. These variables or parameters may include, for example, among other things, the parameters provided by the peripheral driver upon installation (e.g., EstimatedTransferSize, Frequency and/or SizeVariation), the total memory available and previously allocated by the device, the maximum number of peripheral devices that the electronic device can support, and the number of peripheral devices already supported by the electronic device.

In one exemplary embodiment, the parameters, such as the total available memory on the electronic device and the total number of peripheral devices that the electronic device can support, are determined by the electronic device manufacturer and are, therefore, specific to each individual electronic device. Similarly, the parameters provided by the peripheral drivers upon installation including, EstimatedTransferSize, Frequency, and/or SizeVariation, discussed above, are determined at the time the peripheral driver is developed, are prestored in the memory of the peripheral device and are peripheral-device specific.

As one of ordinary skill in the art will recognize, in order to perform Step 104, the electronic device operating system (or other application) may use any one of many different algorithms that are designed to consider multiple electronic device-specific parameters (e.g., amount of total and previously allocated memory, total number of peripheral devices capable of being supported, number of peripheral devices currently supported, etc.) and peripheral device-specific parameters (e.g., size and frequency of common data transfers, etc.) when calculating the optimal amount of memory to allocate to an individual peripheral device. The following provides an example of just one such algorithm that may be used, and should not be taken as limiting the scope of the present invention to use of this particular algorithm. Other similar algorithms may likewise be used without departing from the spirit and scope of the present invention.

### EXEMPLARY ALGORITHM FOR CALCULATING OPTIMAL MEMORY ALLOCATION

According to one exemplary embodiment, the amount of memory to be reserved for or allocated to a particular peripheral device is defined by the equation:

MemToBeAllocated=(MemToBeGranted+AdditionalMem)*VariationMultiplier. Eq. 1

In one exemplary embodiment, in order to determine the variable MemToBeGranted, the average memory for each potential new peripheral device may first be calculated according to the equation:

$$AveMemForBuffer = \frac{( MemTotal - MemUsed )}{( BuffersTotal - BuffersUsed )} , \qquad Eq . 2$$

wherein MemTotal refers to the total amount of memory available for all possible peripheral devices, MemUsed refers to the amount of memory currently reserved for or allocated to peripheral devices that have already been installed or connected to the electronic device, BuffersTotal refers to an estimated maximum number of peripheral devices that may be simultaneously connected to the electronic device (as noted above, this parameter is likely determined at the time the electronic device is manufactured and is, therefore, electronic device-specific), and BuffersUsed refers to the number of peripheral devices that have already (and are currently) connected to the electronic device.

Once AveMemForBuffer has been calculated, according to one exemplary embodiment, this value is compared to the EstimatedTransferSize provided by the peripheral driver upon installation. If EstimatedTransferSize is equal to or less than the AveMemForBuffer (i.e., the estimated size of a common data transfer associated with the peripheral device is less than or equal to the average amount of memory available for each potential new peripheral device), then MemToBeGranted will be set to the EstimatedTransferSize. In addition, where EstimatedTransferSize is equal to or less than the AveMemForBuffer, then the variable AdditionalMem is set to zero, such that the memory to be reserved for or allocated to the peripheral device is now defined by the following equation:

MemToBeAllocated=(EstimatedTransferSize)*VariationMultiplier Eq. 3

In contrast, where EstimatedTransferSize is greater than the AveMemForBuffer (i.e., the estimated size of a common data transfer associated with the peripheral device is greater than the average amount of memory available for each potential new peripheral device), then the MemToBeGranted is set to the AveMemForBuffer and the amount of additional memory that can be allocated (i.e., AdditionalMem) is then calculated.

According to one exemplary embodiment, if the value of the parameter Frequency provided by the peripheral driver is OCCASIONAL, then the variable AdditionalMem remains zero (i.e., no additional memory over and above the average amount of memory available for each new peripheral device is allocated). If, on the other hand, the value of the parameter Frequency is either CONSTANT or BURST, the amount of additional memory that can be allocated to the peripheral device is defined by the equation:

$$AdditionalMem = \sqrt{\frac{A}{BuffersTotal - BuffersUsed}} * \frac{BuffersUsed + 1}{BuffersTotal} * \sqrt{\frac{BuffersTotal * ( MemTotal - MemUsed )}{MemTotal * ( BuffersTotal - BuffersUsed )}} * G \qquad Eq . 4$$

wherein G is the smaller of the EstimatedTransferSize or the variable MemLeft, which refers to the amount of memory still available on the electronic device and is equal to the difference between the total amount of memory available (MemTotal) and the amount of memory already reserved for or allocated to other peripheral devices (MemUsed).

The variable A refers to the amount of extra memory needed and is calculated based on the equation:

$$A = \frac{( EstimatedTransferSize - AveMemForBuffer )}{AveMemForBuffer} , \qquad Eq . 5$$

unless the difference between the estimated transfer size and the average amount of memory available for each potential new peripheral device is greater than the total amount of memory available (i.e., (EstimatedTransferSize−AveMemForBuffer)>MemLeft), in which case A is equal to the number of potential new peripheral devices (i.e., A=(BuffersTotal−BuffersUsed)).

Returning now to Eq. 1, the VariationMultiplier must then be determined. According to one exemplary embodiment, the VariationMultiplier is one (i.e., it does not increase or decrease the amount of memory to be allocated), unless either: (1) Frequency is CONSTANT; or (2) Frequency is OCCASIONAL and MemToBeGranted is greater than

$$\frac{( MemTotal - MemUsed )}{10 * ( BuffersTotal - BuffersUsed )} . \qquad Eq . 6$$

If either of the above is true, the VariationMultiplier is calculated based on the following equation:

$$VariationMultiplier = \frac{( SizeVariation + 50 )}{100} , \qquad Eq . 7$$

wherein, as noted above, SizeVariation is a variation estimate that may be in the form of some integer value between 0 and 100. However, where the Frequency is CONSTANT, according to one exemplary embodiment, the VariationMultiplier cannot be less than one. In contrast, when Frequency is OCCASIONAL, the VariationMultiplier cannot be greater than one.

Using the foregoing, or any similar, algorithm, the electronic device operating system can efficiently and more accurately calculate an appropriate amount of memory to reserve for each new peripheral device that is connected to the electronic device. Exemplary embodiments of the present invention, therefore, increase an electronic device's ability to simultaneously accommodate multiple peripheral devices (e.g., by reducing the likelihood of over-allocation of memory) and enhance the performance of the peripheral devices that are connected to the electronic device (e.g., by reducing the risk of under-allocation of memory).

### MOBILE DEVICE

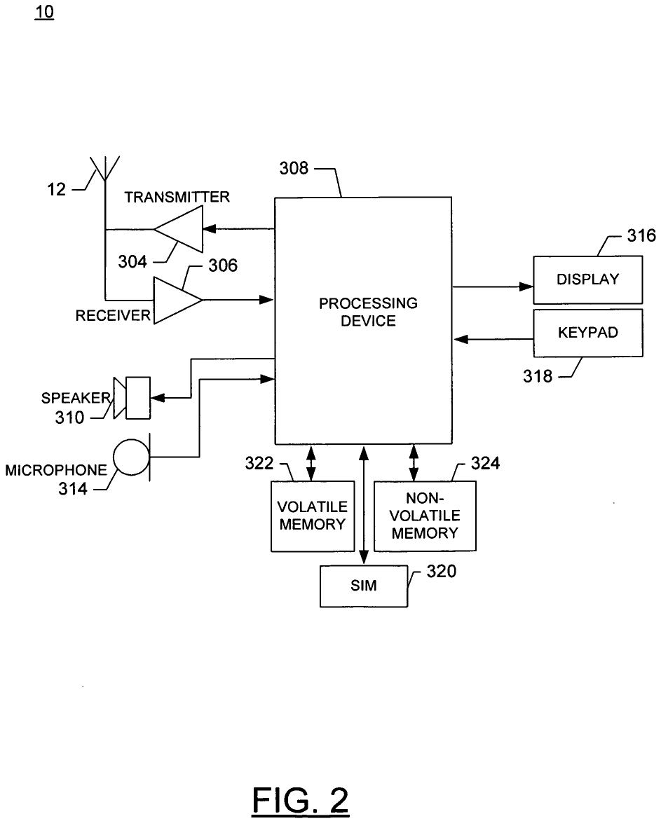

Reference is now made to FIG. 2, which illustrates one type of electronic device that would benefit from embodiments of the present invention. As shown, the electronic device may be a mobile station 10, and, in particular, a cellular telephone. It should be understood, however, that the mobile station illustrated and hereinafter described is merely illustrative of one type of electronic device that would benefit from embodiments of the present invention and, therefore, should not be taken to limit the scope of the present invention. While several embodiments of the mobile station 10 are illustrated and will be hereinafter described for purposes of example, other types of mobile stations, such as personal digital assistants (PDAs), pagers, as well as other types of electronic systems including both mobile, wireless devices and fixed, wireline devices, can readily employ embodiments of the present invention.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, as shown in FIG. 2, in addition to an antenna 302, the mobile station 10 may include a transmitter 304, a receiver 306, and means, such as a processing device 308, e.g., a processor, controller or the like, that provides signals to and receives signals from the transmitter 304 and receiver 306, respectively. The mobile station may further include a circuit assembly, such as an integrated circuit assembly or an assembly of discrete components, including one or more logic elements or circuit components integral or otherwise in communication with the mobile station or more particularly, for example, the processing device 308 of the mobile station configured to perform the steps discussed herein for optimally allocating memory. The signals provided to and received from the transmitter 304 and receiver 306 may include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 308, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 308 thus also includes the functionality to convolutionally encode and interleave message and data prior to modulation and transmission. Further, the processing device 308 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 310, a microphone 314, a display 316, all of which are coupled to the controller 308. The user input interface, which allows the mobile device to receive data, can comprise any of a number of devices allowing the mobile device to receive data, such as a keypad 318, a touch display (not shown), a microphone 314, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 320, a removable user identity module (R-UIM) (not shown), or the like, which typically stores information elements related to a mobile subscriber. In addition to the SIM, the mobile device can include other memory. In this regard, the mobile station can include volatile memory 322, as well as other non-volatile memory 324, which can be embedded and/or may be removable. For example, the other non-volatile memory may be embedded or removable multimedia memory cards (MMCs), secure digital (SD) memory cards, Memory Sticks, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for calculating an optimal amount of memory to allocate to one or more peripheral devices based on multiple electronic and/or peripheral device-specific parameters or variables.

The method, electronic device, computer program product and circuit assembly of exemplary embodiments of the present invention are primarily described in conjunction with mobile communications applications. It should be understood, however, that the method, electronic device, computer program product and circuit assembly of embodiments of the present invention can be utilized in conjunction with a variety of other applications, both in the mobile communications industries and outside of the mobile communications industries. For example, the method, electronic device, computer program product and circuit assembly of exemplary embodiments of the present invention can be utilized in conjunction with wireline and/or wireless network (e.g., Internet) applications.

In addition, as one of ordinary skill in the art will recognize, while in the foregoing exemplary embodiments, the electronic device itself has performed all of the recited steps for allocating an appropriate amount of memory to various peripheral devices, in other exemplary embodiments, some other device in communication with the electronic device may perform the necessary calculations, and then provide the resulting memory allocation to the electronic device. In particular, a device that is, for example, in communication with the electronic device over a communication network (e.g., a local area network (LAN), a metropolitan area network (MAN) and/or a wide area network (WAN)), or a device, such as a laptop or personal computer to which the electronic device is connected or docked, may receive the aforementioned, or similar, parameters from the electronic device and/or from a network entity associated with the peripheral device developer or manufacturer. The device may then perform the abovementioned, or similar, calculations, and then provide an indication of the optimal memory allocation to the electronic device.

### CONCLUSION

As described above and as will be appreciated by one skilled in the art, embodiments of the present invention may be configured as a method, electronic device or circuit assembly. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Exemplary embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of allocating memory to one or more peripheral devices, said method comprising:
receiving one or more parameters associated with a peripheral device; and
calculating an amount of memory to allocate to the peripheral device based at least in part on the one or more parameters received.

2. The method of claim 1, wherein the one or more parameters received are configured to provide an indication of a size and a frequency associated with a common data transfer associated with the peripheral device.

3. The method of claim 2, wherein the one or more parameters are selected from a group consisting of an estimated size of a common data transfer, a frequency associated with the common data transfer, and a variation estimate associated with the estimated size of the common data transfer.

4. The method of claim 1, wherein receiving one or more parameters comprises receiving the one or more parameters upon installation of a peripheral driver associated with the peripheral device to an electronic device.

5. The method of claim 4, wherein calculating an amount of memory to allocate further comprises calculating the amount of memory to allocate based at least on part on one or more parameters associated with the electronic device.

6. The method of claim 5 further comprising:
determining a total amount of memory available for one or more peripheral devices;
determining an amount of memory previously allocated to one or more peripheral devices; and
calculating an amount of memory remaining based on the total amount of memory available and the amount of memory previously allocated, wherein calculating the amount of memory to allocate based at least in part on one or more parameters associated with the electronic device comprises calculating the amount to allocate based at least in part on the amount of memory remaining.

7. The method of claim 5 further comprising:
determining a maximum number of peripheral devices capable of being simultaneously connected to the electronic device;
determining a number of peripheral devices currently connected to the electronic device; and
calculating a number of potential peripheral devices based on the maximum number of peripheral devices and the number of currently connected peripheral devices, wherein calculating the amount of memory to allocate based at least in part on one or more parameters associated with the electronic device comprises calculating the amount to allocate based at least in part on the number of potential peripheral devices.

8. An electronic device configured to allocate memory to one or more peripheral devices, said electronic device comprising:
a processor; and
a memory in communication with the processor, said memory storing an application executable by the processor, wherein the application is configured, upon execution, to receive one or more parameters associated with a peripheral device, said application further configured, upon execution, to calculate an amount of memory to allocate to the peripheral device based at least in part on the one or more parameters received.

9. The electronic device of claim 8, wherein the one or more parameters received are configured to provide an indication of a size and a frequency associated with a common data transfer associated with the peripheral device.

10. The electronic device of claim 9, wherein the one or more parameters are selected from a group consisting of an estimated size of a common data transfer, a frequency associated with the common data transfer, and a variation estimate associated with the estimated size of the common data transfer.

11. The electronic device of claim 8, wherein the application is further configured to receive the one or more parameters upon installation of a peripheral driver associated with the peripheral device.

12. The electronic device of claim 8, wherein the application is further configured to calculate the amount of memory to allocate based at least on part on one or more parameters associated with the electronic device.

13. The electronic device of claim 12, wherein the application is further configured, upon execution, to:
determine a total amount of memory available for one or more peripheral devices;
determine an amount of memory previously allocated to one or more peripheral devices; and
calculate an amount of memory remaining based on the total amount of memory available and the amount of memory previously allocated, wherein calculating the amount of memory to allocate based at least in part on one or more parameters associated with the electronic device comprises calculating the amount to allocate based at least in part on the amount of memory remaining.

14. The electronic device of claim 12, wherein the application is further configured, upon execution, to:
determine a maximum number of peripheral devices capable of being simultaneously connected to the electronic device;
determine a number of peripheral devices currently connected to the electronic device; and
calculate a number of potential peripheral devices based on the maximum number of peripheral devices and the number of currently connected peripheral devices, wherein calculating the amount of memory to allocate based at least in part on one or more parameters associated with the electronic device comprises calculating the amount to allocate based at least in part on the number of potential peripheral devices.

15. A computer program product for allocating memory to one or more peripheral devices, wherein the computer program product comprises at least one computer-readable storage medium having computer-readable program code portions stored therein, the computer-readable program code portions comprising:
a first executable portion for receiving one or more parameters associated with a peripheral device; and
a second executable portion for calculating an amount of memory to allocate to the peripheral device based at least in part on the one or more parameters received.

16. The computer program product of claim 15, wherein the one or more parameters received by the first executable portion are configured to provide an indication of a size and a frequency associated with a common data transfer associated with the peripheral device.

17. The computer program product of claim 16, wherein the one or more parameters are selected from a group consisting of an estimated size of a common data transfer, a frequency associated with the common data transfer, and a variation estimate associated with the estimated size of the common data transfer.

18. The computer program product of claim 15, wherein the first executable portion is configured to receive the one or more parameters upon installation of a peripheral driver associated with the peripheral device to an electronic device.

19. The computer program product of claim 18, wherein the second executable portion is configured to calculate the amount of memory to allocate based at least on part on one or more parameters associated with the electronic device.

20. The computer program product of claim 19, wherein said computer-readable program code portions further comprise:
a third executable portion for determining a total amount of memory available for one or more peripheral devices;
a fourth executable portion for determining an amount of memory previously allocated to one or more peripheral devices; and
a fifth executable portion for calculating an amount of memory remaining based on the total amount of memory available and the amount of memory previously allocated, wherein the second executable portion is further configured to calculate the amount to allocate based at least in part on the amount of memory remaining.

21. The computer program product of claim 19, wherein said computer-readable program code portions further comprise:
a third executable portion for determining a maximum number of peripheral devices capable of being simultaneously connected to the electronic device;
a fourth executable portion for determining a number of peripheral devices currently connected to the electronic device; and
a fifth executable portion for calculating a number of potential peripheral devices based on the maximum number of peripheral devices and the number of currently connected peripheral devices, wherein the second executable portion is further configured to calculate the amount to allocate based at least in part on the number of potential peripheral devices.

22. A circuit assembly for allocating memory to one or more peripheral devices, the circuit assembly comprising:
a first logic element for receiving one or more parameters associated with a peripheral device; and
a second logic element for calculating an amount of memory to allocate to the peripheral device based at least in part on the one or more parameters received.

23. The circuit assembly of claim 22, wherein the one or more parameters received by the first logic element are configured to provide an indication of a size and a frequency associated with a common data transfer associated with the peripheral device.

24. The circuit assembly of claim 23, wherein the one or more parameters are selected from a group consisting of an estimated size of a common data transfer, a frequency associated with the common data transfer, and a variation estimate associated with the estimated size of the common data transfer.

25. The circuit assembly of claim 22, wherein the first logic element is configured to receive the one or more parameters upon installation of a peripheral driver associated with the peripheral device to an electronic device.

26. The circuit assembly of claim 25, wherein the second logic element is configured to calculate the amount of memory to allocate based at least on part on one or more parameters associated with the electronic device.

27. The circuit assembly of claim 26, wherein said computer-readable program code portions further comprise:
a third logic element for determining a total amount of memory available for one or more peripheral devices;
a fourth logic element for determining an amount of memory previously allocated to one or more peripheral devices; and
a fifth logic element for calculating an amount of memory remaining based on the total amount of memory available and the amount of memory previously allocated, wherein the second logic element is further configured to calculate the amount to allocate based at least in part on the amount of memory remaining.

28. The circuit assembly of claim 26, wherein said computer-readable program code portions further comprise:
a third logic element for determining a maximum number of peripheral devices capable of being simultaneously connected to the electronic device;
a fourth logic element for determining a number of peripheral devices currently connected to the electronic device; and
a fifth logic element for calculating a number of potential peripheral devices based on the maximum number of peripheral devices and the number of currently connected peripheral devices, wherein the second logic element is further configured to calculate the amount to allocate based at least in part on the number of potential peripheral devices.

29. An apparatus for allocating memory to one or more peripheral devices, said apparatus comprising:
means for receiving one or more parameters associated with a peripheral device; and
means for calculating an amount of memory to allocate to the peripheral device based at least in part on the one or more parameters received.

30. The apparatus of claim 29, wherein the one or more parameters received are configured to provide an indication of a size and a frequency associated with a common data transfer associated with the peripheral device.
